(19) United States
(12) Patent Application Publication
(10) Pub. No.: US 2015/0230016 A1
(43) Pub. Date: Aug. 13, 2015

(54) CINCH

(71) Applicant: Harman International Industries, Incorporated, Stamford, CT (US)

(72) Inventors: Seth D. Burgett, Glen Carbon, IL (US); Richard J. Daniels, St. Louis, MO (US); Michael Ian Bolster, St. Louis, MO (US); Ryan Alexander Ott, St. Louis, MO (US); Eric M. Sia, St. Louis, MO (US); Effrosini A. Karayiannis, St. Louis, MO (US); Grace Meyer, Hannibal, MO (US); Michael Joseph Spenner, Town & Country, MO (US); Jason David Walker, St. Louis, MO (US); Jason Edward Emde, Ballwin, MO (US)

(21) Appl. No.: 14/178,262

(22) Filed: Feb. 11, 2014

(51) Int. Cl. H04R 1/10

(52) U.S. Cl. CPC H04R 1/1033

(57) ABSTRACT

A cable cinch for an earphone cable includes first and second cinch elements. The first element has a top and a bottom with a sidewall therebetween, front and rear openings in the sidewall, and first and second posts extending between the top and bottom walls, intermediate the front and rear openings. The second element has a top and a bottom with a sidewall therebetween, front and rear openings in the sidewall, and first and second posts extending between the top and bottom walls, intermediate the front and rear openings. The first and second elements are arranged with their rear openings facing toward each other to define a generally S-shaped cable path between the front openings of the first and second elements, the cable path extending from the front opening of the first element between a post and the sidewall of the first element and out the rear opening of the first element, through the rear opening of the second element, around a post in the second cinch element and back out the rear opening of the second cinch element, into rear opening of the first element, around a post in the first element, and out the rear opening of the first element, into the rear opening of the second element, between a post and the sidewall of the second element, and out the front opening of the second cinch element, the cable extending through the generally S-shaped cable path.

### FIELD

This invention relates to headphones of the type where the left and right earphones are joined by a cable, and more specifically to a device for selectively tensioning the cable between earphones to provide the desired tautness of the cable.

### BACKGROUND

This section provides background information related to the present disclosure which is not necessarily prior art.

Running is one of the most popular forms of exercise throughout the world. A large percentage of people who run prefer to listen to music while they run. It has recently been shown through studies that people who listen to music while they exercise get more out of their exercise, i.e., they work harder when they exercise to music.

Wireless headphones, such as those employing Bluetooth wireless technology are growing in popularity, particularly among runners, who appreciate the comfort and convenience of not having to tether their earphones to a phone or mp3 player. While these earphones are called “wireless” there typically is a wire or cable connecting the left and right earphones. This cable allows the headphones to share a single circuit board and antenna. This cable often presents an inconvenience for users partly because a wire in a wireless product is counterintuitive and obtrusive.

The wire that connects the two channels, while it is sometimes thin, it is often found uncomfortable because headphone manufacturers almost exclusively employ a one-sizes-fits-all approach. By doing this, the wire is designed to fit all users, which results in some users finding the wire to be too long for their ideal fit. When this wire is not the optimal length users find it bounces while running, making it irritating and uncomfortable. Some users attempt to alleviate this discomfort by clipping the wire to a hat or their hair, which is not satisfactory, but this is not satisfactory to all users. Existing cinches are not conducive to running or exercising: they are often cumbersome and do not function for the needs of an athlete.

### SUMMARY

This section provides a general summary of the disclosure, and is not a comprehensive disclosure of its full scope or all of its features.

Embodiments of this invention provide a modular clip for adjusting the length of the cable in wireless earphones.

The various embodiments are of relatively simple construction and are easy to use, providing for custom adjustment of the wire in wireless earphones. The various embodiments of the clip generally can be made inexpensively. At least some embodiments of the modular clip can be retrofit to existing wireless earphones.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a top plan view of a cinch constructed according to the principles of this invention;

FIG. 2 is a side elevation view of the cinch;

FIG. 3 is a side elevation view of the cinch;

FIG. 4 is an end elevation view of the cinch;

FIG. 5 is an end elevation view of the cinch;

FIG. 6 is a cross sectional view of the cinch; and

FIG. 7 is a cross-sectional view of the cinch, showing the cable path.

Corresponding reference numerals indicate corresponding parts throughout the several views of the drawings.

### DETAILED DESCRIPTION

Example embodiments will now be described more fully with reference to the accompanying drawings.

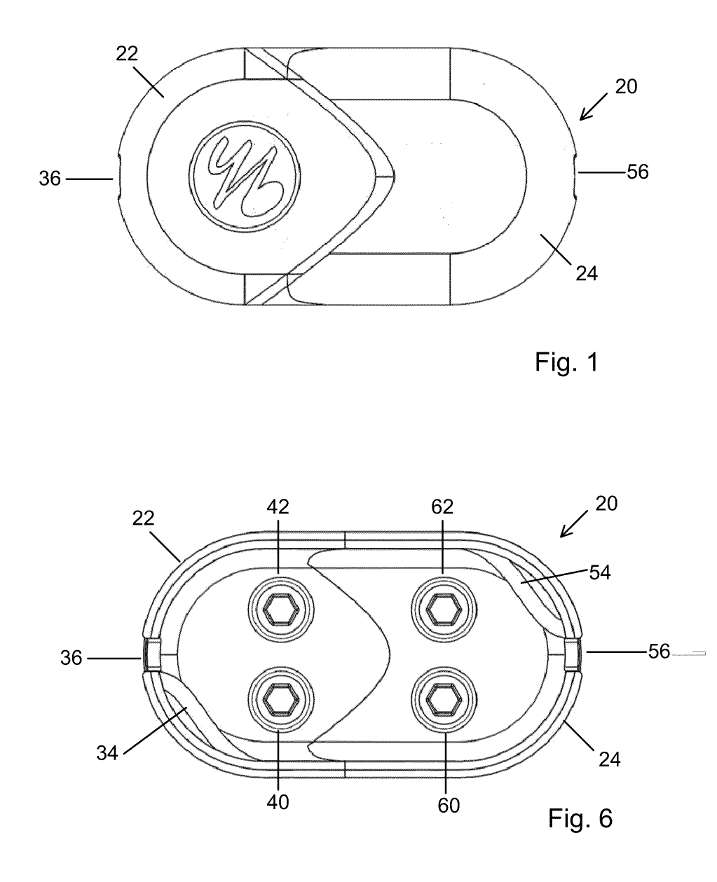

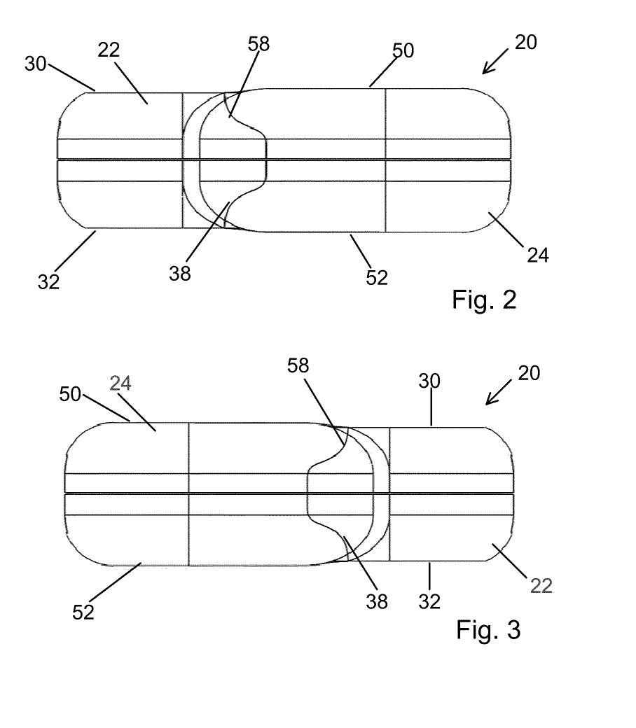

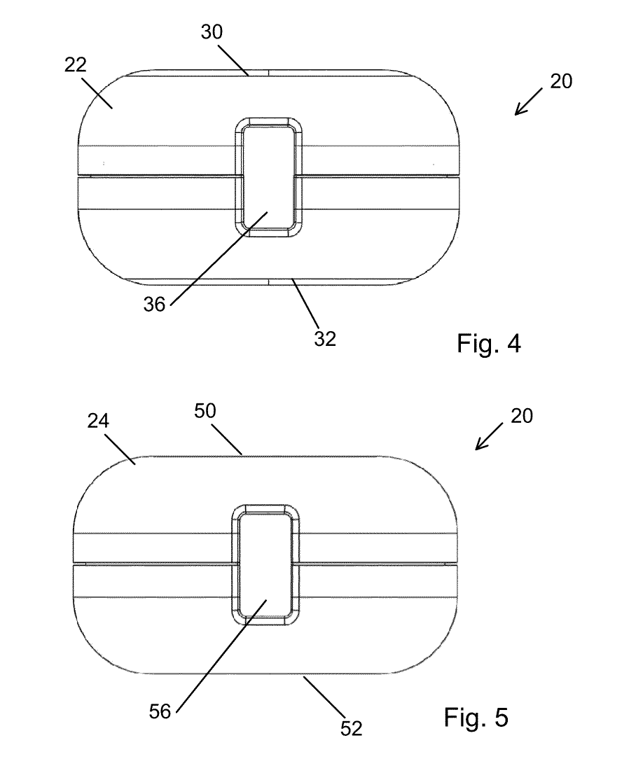

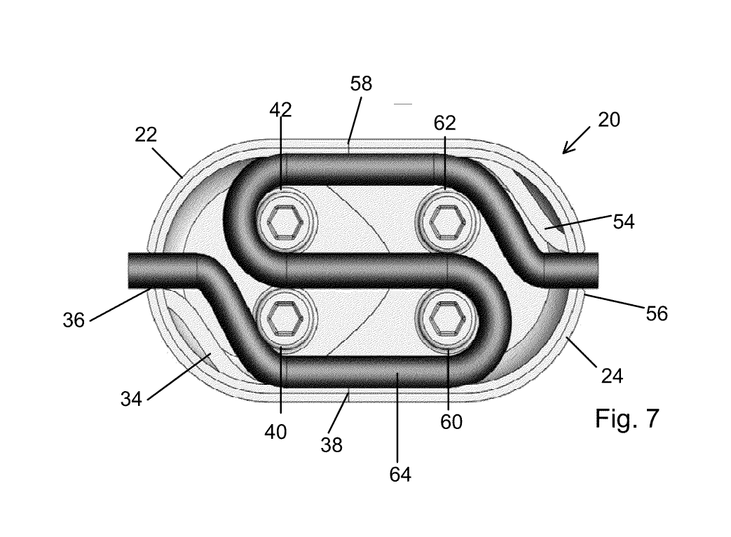

A cable cinch in accordance with the principles of this invention is indicated generally as 20 in FIGS. 1-7. The cable cinch 20 comprises first and second cable cinch elements 22 and 24. The first element 22 has a top 30, a bottom 32 and a sidewall 34 therebetween. The first element has a front opening 36 and a rear opening 38 in the sidewall 34. First and second posts 40 and 42 extend between the top 30 and bottom 32, intermediate the front and rear openings 36 and 38.

The second element 24 has a top 50, a bottom 52 and a sidewall 54 therebetween. The second element has a front opening 56 and a rear opening 58 in the sidewall 54. First and second posts 60 and 62 extend between the top 50 and bottom 52, intermediate the front and rear openings 56 and 58.

The first and second elements 22 and 24 are arranged with their rear openings 38 and 58 facing toward each other to define a generally S-shaped cable path 64 between the front openings 36 and 56 of the first and second elements 22 and 24. The cable path 64 extends from the front opening 36 of the first element 22 between post 40 and the sidewall 34 of the first element 22 and out the rear opening 38 of the first element. The cable path 64 continues through the rear opening 38 of the second element 24, around post 60 in the second element and back out the rear opening of the second element. The cable path 64 continues into rear opening 30 of the first element 22, around post 42 in the first element, and out the rear opening 38 of the first element. The cable path 64 continues into the rear opening 58 of the second element, between post 62 and the sidewall 54 of the second element, and out the front opening 56 of the second element.

The cable between the left and right earphones extends through the generally S-shaped cable path 64. The posts can be provided with a slick material, such as Teflon, or then can be provided with rollers, to facilitate the movement of the cable through the cinch.

The first and second elements 22 and 24 preferably releasably interfit. When the first and second elements 22 and 24 are interfit, the S-shaped path 64 is the shortest, by separating the first and second elements 22 and 24, the S-shaped path can be extended, shortening the effective length of the cable. The cinch 20 thus provides a method of adjusting the effective length of earphone cables such as the cables between earphones in wireless earphones.

The tops 30 and 50 of each of the first and second elements are preferably seperable from the bottoms 32 and 52, so that the wire can be inserted into the cable path 64, allowing the cable cinch to be retro fit to existing earphones.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. In combination with an earphone cable, a cable cinch, the cable cinch comprising first and second cinch elements,
the first element having a top and a bottom with a sidewall therebetween, front and rear openings in the sidewall, and first and second posts extending between the top and bottom walls, intermediate the front and rear openings;
the second element having a top and a bottom with a sidewall therebetween, front and rear openings in the sidewall, and first and second posts extending between the top and bottom walls, intermediate the front and rear openings;
the first and second elements arranged with their rear openings facing toward each other to define a generally S-shaped cable path between the front openings of the first and second elements, the cable path extending from the front opening of the first element between a post and the sidewall of the first element and out the rear opening of the first element, through the rear opening of the second element, around a post in the second cinch element and back out the rear opening of the second cinch element, into rear opening of the first element, around a post in the first element, and out the rear opening of the first element, into the rear opening of the second element, between a post and the sidewall of the second element, and out the front opening of the second cinch element, the cable extending through the generally S-shaped cable path.

2. The combination according to claim 1 wherein the first and second elements releasably interfit.
